(19) United States
(12) Patent Application Publication
(10) Pub. No.: US 2001/0024911 A1
(43) Pub. Date: Sep. 27, 2001

(54) Feedthrough terminal block, particularly for connecting electric cables in lines or systems for electric traction

(75) Inventors: Romano Bre', Siziano (IT); Daniele Bossi, Milano (IT)

Correspondence Address: MODIANO & ASSOCIATI, Via Meravigli, 16, MILANO, 20123, IT

(73) Assignee: CO.E.P.T.E. COSTRUZIONI ELETTROMECCANICHE PER TRAZIONE ELETTRICA S.r.l.

(21) Appl. No.: 09/800,653

(22) Filed: Mar. 8, 2001

(30) Foreign Application Priority Data
Mar. 23, 2000 (IT) MI2000A000617

(51) Int. Cl. H01R 9/22

(52) U.S. Cl. 439/717

(57) ABSTRACT

A feedthrough terminal block, particularly for connecting electric cables in lines or systems for electric traction, constituted by a modular structure composed of at least two modules which are mutually associated side by side. At least one of the modules is composed of a supporting element made of electrically insulating material which supports at least one pair of terminals made of electrically conducting material, which protrude from two opposite faces of the supporting element and are electrically interconnected. The supporting element is provided, on at least one of the faces that support the terminals, with at least one insulating wing which is adapted to separate the corresponding terminal from terminals of contiguous modules or from the outside. The terminal block comprises means for mutually assembling the various modules and means for fixing the terminal block to a wall at an opening formed in the wall itself.

### BACKGROUND OF THE INVENTION

The present invention relates to a feedthrough terminal block, particularly for connecting electric cables in lines or systems for electric traction.

In electric lines or systems, when it is necessary to interconnect electric cables located in spaces separated by walls, one resorts to so-called “feedthrough” terminals. In the field of electric traction, a requirement of this kind arises, for example, in the provision of the electric connections between the various cars and the locomotive that compose a train.

In order to meet this requirement, individual terminals are currently used being substantially constituted by a shaft or pin made of electrically conducting material which is embedded, except for its end regions, which are threaded, in a supporting body made of an electrically insulating material. The supporting body has a shape which tapers in a frustum-like fashion toward the ends of the shaft, and has, in an intermediate region of its axial extension, a flange with holes which are used to fix the terminal to the wall by means of bolts.

The ends of the electric cables to be interconnected are fixed to the ends of the shaft or pin of the terminal by means of nuts.

The use of these terminals has drawbacks.

Since currently commercially available feedthrough terminals are only single units, when it is necessary to provide a plurality of connections it is necessary to use a plurality of terminals which must be arranged side by side and inserted individually through the wall. This entails, for each terminal, the provision of a hole for the passage of the supporting element and of several holes for bolting the terminal to the wall.

Moreover, for safety reasons, it is necessary to adequately space the various terminals in order to avoid the danger of contacts or electrical discharges between the cables and the terminals.

For these reasons, when there are several connections to be performed, the installation of terminals of this kind is complicated and occupies considerable space on the wall, causing problems also during design, since it limits the wall space available for installations of other kinds.

Moreover, the mutual spacing of the various feedthrough terminals is not always sufficient to avoid contacts or discharges between the electrical conductors. Particularly in mobile systems, the electric cables are in fact subject to movements and vibrations which can loosen their coupling on the terminal. A reduction in the coupling force is dangerous in conventional terminals which have a single shaft or pin, since the electric cable can rotate around the shaft and move toward the connections of the contiguous electric cables.

### SUMMARY OF THE INVENTION

The aim of the present invention is to solve the above problems, by providing a feedthrough terminal block, particularly for connecting electric cables in lines or systems for electric traction, which allows to provide a plurality of connections in safety conditions and with reduced overall dimensions with respect to conventional feedthrough terminals.

Within this aim, an object of the invention is to provide a terminal block which is easy and quick to install.

Another object of the invention is to provide a terminal block in which the number of available terminals can be changed according to requirements.

Another object of the invention is to provide a terminal block which effectively avoids any mutual approach of the connection ends of the electric cables that are connected thereto.

This aim and these and other objects which will become better apparent hereinafter are achieved by a feedthrough terminal block, particularly for connecting electric cables in lines or systems for electric traction, characterized in that it is constituted by a modular structure composed of at least two modules being mutually associated side by side, at least one of said two modules being composed of a supporting element made of electrically insulating material which supports at least one pair of terminals made of electrically conducting material, which protrude from two opposite faces of said supporting element and are electrically interconnected; said supporting element being provided, on at least one of the faces that support said terminals, with at least one insulating wing which is adapted to separate the corresponding terminal from terminals of contiguous modules or from the outside, means being provided for mutually assembling said modules and for fixing the terminal block to a wall at an opening formed in the wall.

### BRIEF DESCRIPTION OF THE DRAWINGS

Further characteristics and advantages of the invention will become better apparent from the following detailed description of two preferred but not exclusive embodiments of the terminal block according to the invention, illustrated only by way of non-limitative example in the accompanying drawings, wherein:

FIG. 1 is a sectional view of a first embodiment of the terminal block according to the invention, taken along a plane which is perpendicular to a wall to which it is to be applied;

FIG. 2 is an exploded perspective view of the terminal block of FIG. 1;

FIG. 3 is a sectional view of a second embodiment of the terminal block according to the invention, taken like FIG. 1;

FIG. 4 is a sectional view of the terminal block of FIG. 3, taken along the line IV-IV;

FIG. 5 is a sectional view of the terminal block of FIG. 3, taken along the line V-V;

FIG. 6 is an exploded perspective view of two modules of the terminal block of FIG. 3.

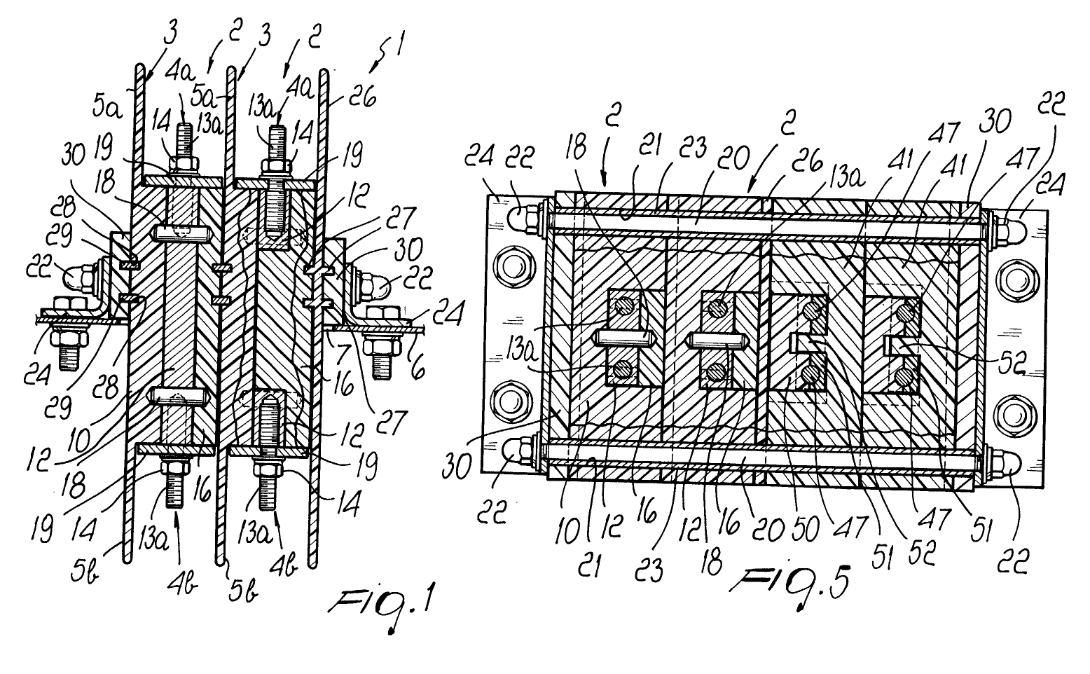

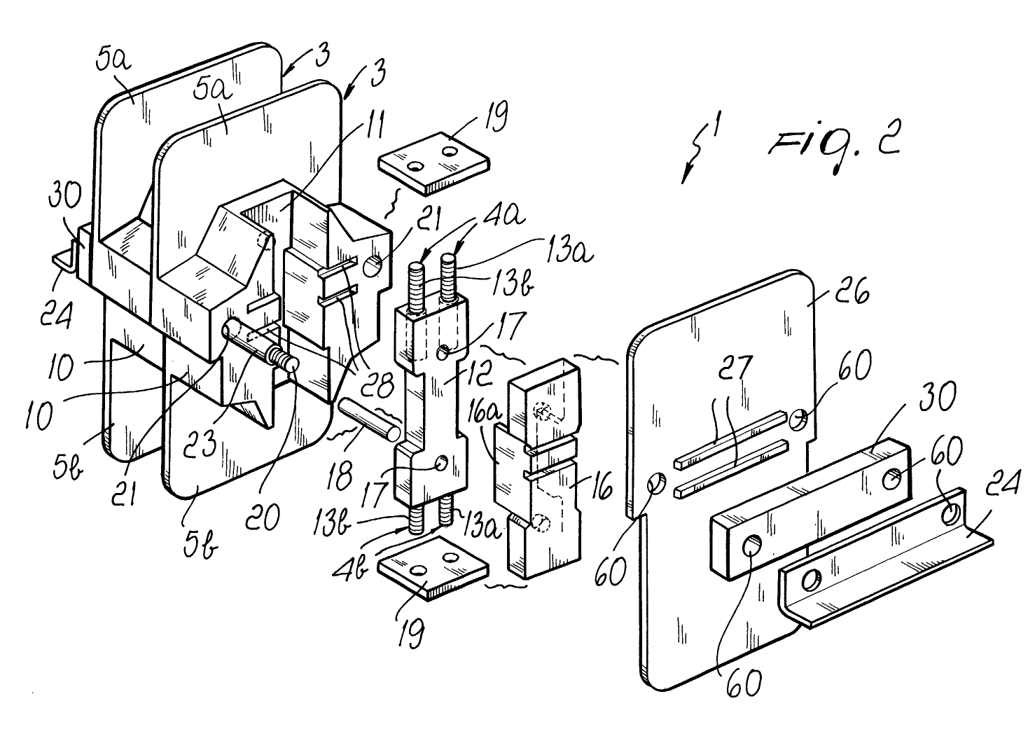

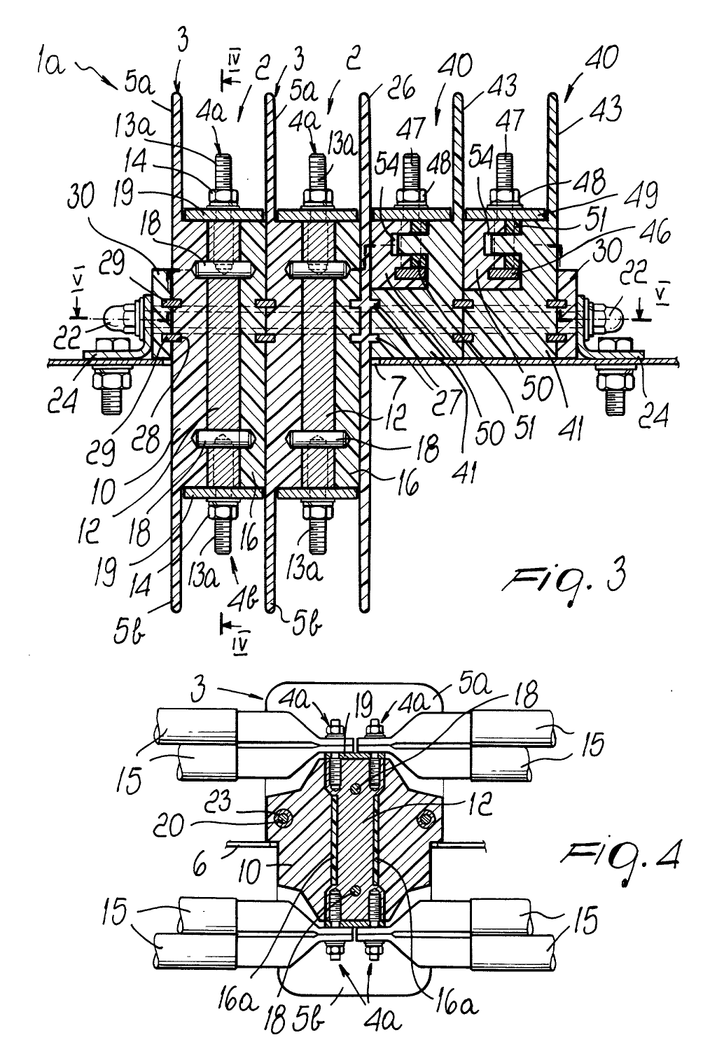

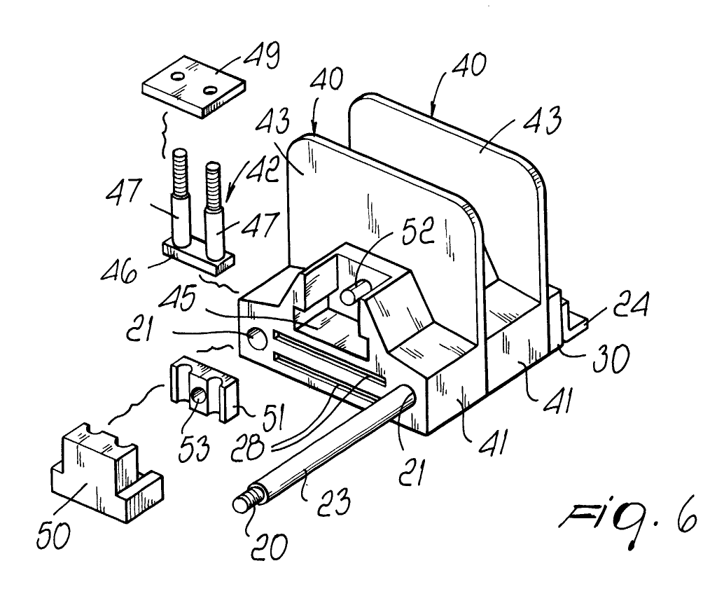

### DESCRIPTION OF THE PREFERRED EMBODIMENTS

With reference to the figures, the terminal block according to the invention, generally designated by the reference numeral 1 in its first embodiment, is constituted by a modular structure composed of at least two modules which are mutually associated side by side. In this first embodiment, the terminal block is constituted by two mutually identical modules 2 but it might also be constituted by mutually different modules.

The module 2 is composed of a supporting element 3 made of electrically insulating material which supports at least one pair of terminals 4a and 4b made of electrically conducting material, which protrude from two opposite faces of the supporting element 3 and are electrically connected to each other.

The supporting element 3 has, on at least one of its faces that support the terminals, an insulating wing 5a, 5b which is adapted to separate the corresponding terminal 4a, 4b from terminals of contiguous modules or from the outside.

The terminal block according to the invention comprises means for mutually assembling the various modules and means for fixing the terminal block 1 to a wall 6 at an opening 7 formed in the wall 6.

More particularly, the supporting element 3 is constituted by a member 10 which is made of electrically insulating material and is shaped substantially like a parallelepiped; a seat 11 is formed on one of its lateral faces and accommodates a member 12 made of electrically conducting material.

The member 12 is preferably shaped substantially like a parallelepiped, with wider portions at its ends. The member 12 has, on its two ends, the terminals 4a, 4b, each whereof is conveniently constituted by two threaded pins 13a, 13b which are screwed into threaded seats formed correspondingly in the ends of the member 12. The threaded pins 13a, 13b protrude from the opposite ends of the member 10 and can be engaged by bolts 14 by means of which it is possible to couple the end of electric cables 15 to be connected to the terminal block.

The seat 11, in which the member 12 is inserted, is conveniently closed by a cover 16 made of electrically insulating material, being shaped like the member 12 and being provided with a pair of wings 16a which laterally wrap around the member 12. The member 12 is crossed by two first holes 17 which are aligned with second holes formed in the member 10 and in the cover 16. Pins 18 can be inserted in said first and second holes and facilitate the assembly and mutual positioning of the member 10, of the member 12 and of the cover 16.

The wing 5a, 5b is preferably formed monolithically with the member 10 and protrudes as an extension of the lateral face of the member 10 that lies opposite the lateral face in which the seat 11 that accommodates the member 12 and the cover 16 is formed.

In the first embodiment there are two wings 5a, 5b which protrude from both ends of the member 10, but according to requirements it is also possible to provide a single wing affecting only one of the two ends of the member 10.

The module 2 is completed by a plate 19 made of electrically conducting material which is crossed by two holes and is fitted over the threaded pins 13a and 13b under the nuts 14 and the ends of the cables 15.

The means for mutually assembling the various modules are conveniently constituted by one or more traction elements 20, which pass through through holes 21 which are formed in the members 10 and are mutually aligned when the various modules are correctly arranged side by side.

In the illustrated embodiments there are two traction elements 20 arranged side by side, but the number of traction elements can vary according to requirements. The various modules 2 are packed on the traction elements 20 by means of end nuts 22.

Conveniently, the traction elements 20 are covered by tubular bodies 23 made of electrically insulating material which are inserted in the holes 21 and are crossed coaxially by the traction elements 20.

The means for fixing the terminal block to the wall 6 are simply constituted by two L-shaped elements 24 which are connected, with one of their sides, to an end of the traction elements 20 and can be fixed, for example by means of bolts, with their other side to the wall 6 proximate to the opening 7.

Conveniently, the terminal block can comprise an auxiliary wing 26 made of electrically insulating material which can be interposed between two contiguous modules or closes a sequence of modules.

Advantageously, the various modules, on the faces that face each other upon assembly of the terminal block, can be provided with elements for mutual centering. The centering elements can be constituted by protruding is ridges 27, as in the case of the auxiliary wing 26, or can be constituted by slots 28 in which centering bars 29 are accommodated.

Conveniently, spacers 30 made of electrically insulating material can be interposed between the L-shaped elements 24 and the modules that compose the terminal block. Optionally, also the spacers 30 can be provided with centering means like the various modules of the terminal block.

The spacers 30, like the auxiliary wing 26 and the L-shaped elements 24, are crossed by holes 60 through which there pass the traction elements 20 used to assemble the various modules that compose the terminal block.

The second embodiment illustrates a terminal block, generally designated by the reference numeral la, which has two through modules 2 and two non-through modules, generally designated by the reference numeral 40.

As regards the modules 2, reference is made to what has already been described regarding the first embodiment.

The module 40 is composed of a member 41 made of electrically insulating material which is shaped substantially like a parallelepiped and is associated, by means of one of its lateral faces, with the other modules of the terminal block and supports at least one terminal 42 made of electrically conducting material which protrudes from one of its ends. The module 40 has, at least on its end which supports the terminal 42, an insulating wing 43 which is adapted to separate the corresponding terminal 42 from terminals of contiguous modules or from the outside.

The wing 43 is conveniently formed monolithically with the member 41 and protrudes from one of its lateral faces that are connected to the contiguous module or is arranged opposite with respect to the contiguous module.

The member 41 has, on one of its lateral faces, a seat 45 which accommodates a member 46 made of electrically conducting material which supports the terminal 42. The member 46 comprises a base plate, from which two pins 47 rise; the pins protrude, with one of their ends, which is appropriately threaded, from one end of the member 41 and constitute the terminal 42. A nut 48 is screwed onto the threaded end of the pins 47 and is used to couple one end of the cables 15 on the terminal block.

A perforated plate 49 is fitted on the pins 47 and is arranged below the nuts 48 and the end of the cables 15.

The seat 45 is closed by a cover 50 made of electrically insulating material which is coupled to the member 41.

A shaped element 51 made of electrically insulating material is arranged on the side of the seat 45 that lies opposite the cover 50 and partially wraps around the pins 47. The cover 50, in turn, wraps around the remaining part of the pins 47 which is arranged inside the member 41. A centering protrusion 52 protrudes from the side of the seat 45 that lies opposite the cover 50 and passes through a hole 53 which is formed in the element 51 and engages a hole 54 formed correspondingly on the side of the cover 50 that is directed toward the element 51.

Centering means can be provided also on the faces of the members 41 that face each other upon assembly of the terminal block, as already mentioned with reference to the modules 2. The same reference numerals used for the centering means described with reference to the modules 2 have been retained for the centering means.

Also the members 41 are crossed by holes 21 which, when the members 41 are mutually adjacent, during the assembly of the terminal block, are crossed by the traction element 20, by means of which the assembly of the terminal block is completed.

It should be noted that in one or more modules the wings 5a, 5b, 43 may be omitted if there is no danger of contact or discharges between the terminals that belong to two contiguous modules.

According to requirements, the various modules can be mutually assembled by means of one of their lateral faces or with the opposite lateral face.

In practice it has been observed that the terminal block according to the invention fully achieves the intended aim and objects, since it allows to provide a plurality of through connections in safety conditions and with smaller overall dimensions than required by conventional feedthrough terminals.

Another advantage of the terminal block according to the invention is that it effectively avoids the rotation of the ends of the cables about the pins or shafts of the corresponding terminals, owing to the fact that each terminal is provided with two pins or shafts.

The terminal block thus conceived is susceptible of numerous modifications and variations, all of which are within the scope of the inventive concept; all the details may further be replaced with other technically equivalent elements.

In practice, the materials employed, so long as they are compatible with the specific use, as well as the dimensions, may be any according to requirements and the to state of the art.

The disclosures in Italian Patent Application No. MI2000A000617 from which this application claims priority are incorporated herein by reference.

What is claimed is:

1. A feedthrough terminal block, particularly for connecting electric cables in lines or systems for electric traction, comprising a modular structure composed of at least two modules which are mutually associated side by side, at least one of said at least two modules being composed of a supporting element made of electrically insulating material which supports at least one pair of terminals made of electrically conducting material, which protrude from two opposite faces of said supporting element and are mutually electrically connected; said supporting element being provided, on at least one of the faces that support said terminals, with at least one insulating wing which is adapted to separate the corresponding terminal from terminals of contiguous modules or from the outside, means being provided for mutually assembling said modules and for fixing the terminal block to a wall at an opening formed in said wall.

2. The terminal block according to claim 1, wherein said supporting element is constituted by a member made of electrically insulating material which is substantially shaped like a parallelepiped and on a lateral face of which there is a seat which accommodates a member made of electrically conducting material and supports said terminals on two opposite faces, said terminals protruding from the two opposite ends of said member made of electrically insulating material, said seat being closed by a cover made of electrically insulating material which is coupled to said member made of electrically insulating material.

3. The terminal block according to claim 2, wherein said wing is formed monolithically with said member made of electrically insulating material and protrudes as an extension of the lateral face of said member made of electrically insulating material that lies opposite with respect to the lateral face in which said seat is formed.

4. The terminal block according to claim 2, wherein said wing protrudes from both ends of said member made of electrically insulating material.

5. The terminal block according to claim 1, comprising an auxiliary wing which can be interposed between two contiguous modules of said at least two modules.

6. The terminal block according to claim 1, comprising elements for the mutual centering of the various modules.

7. The terminal block according to claim 1, wherein said modules have at least one through hole and in that the through holes of the various modules, when the modules are mutually assembled, are mutually aligned, said means for mutually assembling the various modules comprising at least one traction element which is inserted through said through holes.

8. The terminal block according to claim 2, wherein said terminals comprise, for each end of said member made of electrically insulating material, two threaded pins arranged side by side and nuts which are screwed onto said pin in order to couple ends of electric cables.

9. The terminal block according to claim 7, wherein said means for fixing the terminal block comprise two L-shaped elements which are connected, by means of one of sides thereof, to an end of said at least one traction element, another side thereof being meant to be fixed to said wall proximate to said opening.

10. The terminal block according to claim 9, wherein a spacer made of electrically insulating material is interposed between each one of said L-shaped elements and a contiguous module.

11. The terminal block according to claim 7, wherein said traction element is covered by a tubular body made of electrically insulating material.

12. The terminal block according to claim 1, comprising at least one non-through module composed of a member which is shaped substantially like a parallelepiped, is made of electrically insulating material, and is associated, by way of one of its lateral faces, with the other modules of the terminal block and supports at least one terminal made of electrically conducting material which protrudes from one of its ends.

13. The terminal block according to claim 12, wherein said non-through module has, on its end that supports said terminal, at least one insulating wing which is adapted to separate the corresponding terminal from terminals of contiguous modules or from the outside.

14. The terminal block according to claim 13, wherein said at least one insulating wing of the non-through module is formed monolithically with the member made of electrically insulating material of said non-through module and protrudes as an extension of one of lateral faces thereof which is connected to the contiguous module or lies opposite with respect to the contiguous module.

15. The terminal block according to claim 14, wherein said member made of electrically insulating material of the non-through module has, on one of said lateral faces, a seat which accommodates a member made of electrically conducting material which supports said terminal, said terminal protruding from one end of the member made of electrically insulating material, said seat being closed by a cover made of electrically insulating material which is coupled to said member made of electrically insulating material.

16. The terminal block according to claim 12, wherein said terminal of the non-through module comprises two threaded pins which are arranged side by side, are connected to the member made of electrically conducting material, and protrude from a base of said element made of electrically insulating material, and nuts which are screwed onto said pins in order to couple ends of electric cables.
